(19) United States
(12) Patent Application Publication
(10) Pub. No.: US 2009/0015730 A1
(43) Pub. Date: Jan. 15, 2009

(54) IMAGE PROJECTING METHOD AND PROJECTOR

(76) Inventor: Kazuya Arakawa, Tochigi (JP)

Correspondence Address: BIRCH STEWART KOLASCH & BIRCH, PO BOX 747, FALLS CHURCH, VA, 22040-0747, US

(21) Appl. No.: 12/278,726

(22) PCT Filed: Aug. 10, 2006
(86) PCT No.: PCT/JP2006/315823

§ 371 Date: Aug. 7, 2008

(30) Foreign Application Priority Data
Feb. 10, 2006 (JP) 2006-034271

(51) Int. Cl. H04N 9/31

(52) U.S. Cl. 348/744; 348/E09.025

(57) ABSTRACT

A projector sets a projection range defined as the range occupied by the projection image on a screen (projected surface) and displaces the projection range in the screen coordinate system (projected surface coordinate system) in the case that an instruction on displacing the projection image is accepted. Furthermore, the projector converts the coordinates of the projection range after the displacement in the screen coordinate system into the coordinates in the panel coordinate system, thereby obtaining the location of the range on the image forming panel corresponding to the projection range on the screen. The projector deforms the image so that the original projection image is fitted in the range corresponding to the projection range, forms a panel image containing the deformed image using the image forming panel, and projects the projection image.

This application is the national phase under 35 U.S.C. §371 of PCT International Application No. PCT/JP2006/315823 which has an International filing date of Aug. 10, 2006 and designated the United States of America.

### BACKGROUND

1. Technical Field

The present invention relates to a projector for projecting a rectangular image onto an outer projected surface, such as a screen, more particularly, to an image projecting method and a projector for projecting an image while correcting the shape of the image projected onto a projected surface.

2. Description of Related Art

In the field of presentation or image projection, a projector is used in which image data is accepted from the outside, an image based on the image data is enlarged and projected onto an outer projected surface, such as a screen or a wall. This kind of projector is configured so as to project an image formed as an optical image by forming an image on a flat image forming panel formed of a liquid crystal panel or DMD (Digital Micromirror Device) or the like and by projecting the light reflected by the image forming panel on which the image is formed or the light passing through the image forming panel onto an outer projected surface. Hereafter, an image projected onto a projected surface is referred to as a projection image, and an image formed using the image forming panel is referred to as a panel image.

The shape of a projection image that should be projected by the projector is usually a rectangular shape; in the case that the projector is disposed so as to able to project light perpendicularly onto a projected surface, the projector can project a rectangular projection image onto the projected surface by forming a panel image into a rectangular shape and by projecting light. However, there are many cases in which the projector cannot be disposed so as to able to project light perpendicularly to the projected surface; in such a case, the projector projects light onto the projected surface in an up-down or left-right oblique direction. In the case that the projector projects light onto the projected surface in an oblique direction after a panel image is formed into a rectangular shape, the distance through which the light reaches the projected surface on one end of the image differs from the distance through which the light reaches the projected surface on the other end of the image, and the magnification of the image becomes different, whereby the shape of the projection image is distorted from the rectangular shape. This distortion of the projection image is referred to as keystone distortion. Hence, the projector is required to have a keystone correction function to correct the keystone distortion so that the shape of the projection image is formed into a rectangular shape by projecting light after the shape of the portion corresponding to the projection image in the panel image is deformed from the rectangular shape beforehand.

Various methods have been proposed conventionally as a method in which a projector carries out keystone correction. For example, a technology has been developed in which a projector automatically corrects the shape of a projection image by detecting the shape of the projection image or the distance between the projector and a projected surface and by adjusting the panel image on the basis of the result of the detection. Examples of this technology have been disclosed in Japanese Patent Application Laid-Open No. 2004-187052, Japanese Patent Application Laid-Open No. 2005-12561 and Japanese Patent Application Laid-Open No. 2005-136699. In the case that this technology of automatically carrying out keystone correction is used, although a sensor for detecting data necessary for keystone correction is required for the projector, keystone correction can be carried out easily without requiring time and effort of the user. In addition, another technology has also been used in which the shape of a projection image is corrected by projecting a distorted projection image once or by projecting the outer frame or the four corner points indicating the range of the projection image from a projector, by designating the locations of the points contained in the projection image through the operation of the user so that the shape of the projection image is formed into a rectangular shape having a predetermined aspect ratio, and by adjusting the shape of the portion occupied by the original projection image of the projection image in the panel image. In the case that this technology of carrying out keystone correction through the operation of the user is used, the user can set the shape, size, location, etc. of the projection image as desired to some extent although the time and effort of the user to operate the projector is required.

FIG. 8 is a schematic view schematically showing the process of deforming the original projection image of a projection image to carry out keystone correction. FIG. 8(a) shows an input image input to a projector so as to be projected by the projector. The projector stores the data of the input image and sets a displayable region in which the original projection image of the projection image can be formed using an image forming panel according to the aspect ratio and the resolution of the input image. FIG. 8(b) shows the displayable region set on the image forming panel. The projector sets the shape of the displayable region at the same aspect ratio as that of the input image and sets the size of the displayable region according to the resolution of the input image. The portion other than the displayable region on the image forming panel is used as an offset region in which no image is formed. The projector converts data by carrying out keystone correction to deform the input image and forms a panel image containing the deformed input image using the image forming panel. FIG. 8(c) shows the panel image containing the deformed input image. The imaging range shown in the figure is a region for the input image deformed by keystone correction and is contained in the displayable region. This portion of the imaging range is projected onto a projected surface and becomes a projection image. The portion other than the imaging range in the panel image is projected in white, for example.

### SUMMARY

In the middle that a projector projects a projection image, there is a case in which the location of the projection image is desired to be changed on a projected surface. As methods for changing the location of the projection image, a method for changing the location of the projector itself and a method for changing the location of the projected surface to which light is irradiated by controlling the optical system for projecting the light, without moving the projector itself are available. However, in these methods, since the distance through which the light corresponding to each portion of the projection image reaches the projected surface and the angle of the light to the projected surface are changed from the conditions obtained when the keystone correction setting was carried out, the keystone distortion cannot be corrected sufficiently by keystone correction and the shape of the projection image is distorted again. In addition, as another method for changing the location of the projection image, it is conceivable to use digital shift in which the location of the projection image on a projected surface is changed by changing the location occupied by the displayable region on the image forming panel, without changing the location of the projector itself and the state of the optical system. However, since the shape of the imaging range corresponding to the projection image has been determined according to the location of the displayable region having been set once, in the case that the location of the displayable region was changed, the keystone distortion cannot be corrected by deforming the original projection image of the projection image into the determined shape of the imaging range, and the shape of the projection image is distorted again. Since the conditions under which keystone correction is carried out are changed each time the location of the projection image is changed on the projected surface as described above in the conventional projectors, there occurs a problem that it is necessary to repeat the keystone correction setting so that the keystone distortion of the projection image can be corrected sufficiently. In particular, in the case of a projector in which the keystone correction setting is carried out through the operation of the user, there occurs a problem that the operation of the user becomes complicated.

In consideration of these circumstances, an object of the present invention is to provide an image projecting method and a projector capable of displacing a projection image on a projected surface by carrying out the digital shift of the projection range while adjusting keystone correction conditions, without carrying out keystone correction setting again.

Furthermore, another object of the present invention is to provide a projector capable of securely projecting a projection image after carrying out displacement on a projected surface by determining an amount of displacement of the projection range in a range in which digital shift is made possible.

An image projecting method according to the present invention for projecting a projection image from a projector onto an outer projected surface by forming an image using a flat image forming panel and by projecting the light from the image forming panel in which the image is formed to the projected surface, is characterized by comprising the steps of setting a projection range occupied by the projection image on the projected surface; determining coordinates of the projection range in a projected surface coordinate system specifying locations on the projected surface; in the case that a displacement instruction on instructing that the projection range should be displaced on the projected surface is accepted, displacing the coordinates of the projection range in the projected surface coordinate system according to the accepted displacement instruction; converting the coordinates of the projection range obtained after the displacement in the projected surface coordinate system into coordinates of a range corresponding to the projection range after the displacement in a panel coordinate system specifying locations on the image forming panel; and forming an image in the range on the image forming panel corresponding to the projection range obtained after the displacement and represented by the converted coordinates.

A projector according to the present invention having a flat image forming panel and means for projecting a projection image onto an outer projected surface by projecting the light from the image forming panel in which an image is formed to the projected surface, is characterized by comprising means for setting a projection range occupied by the projection image on the projected surface; means for obtaining coordinates of a range on the image forming panel corresponding to the projection range on the projected surface by projection in a panel coordinate system specifying locations on the image forming panel; means for determining coordinates of the projection range in a projected surface coordinate system specifying locations on the projected surface; means for calculating a conversion parameter required for a predetermined conversion formula for carrying out mutual conversion between the locations in the panel coordinate system and the locations in the projected surface coordinate system corresponding thereto by projection, on the basis of the coordinates of the range corresponding to the projection range in the panel coordinate system and the coordinates of the projection range in the projected surface coordinate system; means for accepting a displacement instruction on instructing that the projection range should be displaced on the projected surface; means for displacing the projection range in the projected surface coordinate system according to the displacement instruction accepted by the means; means for converting the coordinates of the projection range in the projected surface coordinate system after displacement by the means into coordinates of a range in the panel coordinate system corresponding to the projection range after the displacement, using the conversion parameter; and image forming means for forming an image in the range on the image forming panel corresponding to the projection range obtained after the displacement and represented by the coordinates converted by the means.

The projector according to the present invention is characterized in that the displacement instruction contains information regarding a displacement direction in which the projection range is displaced in the projected surface coordinate system, and that the projector further comprises means for setting a displayable region in which an image can be formed in a portion of the image forming panel according to the aspect ratio of the projection image that should be projected and means for determining an amount of displacement of the projection range in the projected surface coordinate system according to the displacement instruction, depending on an amount of room in which the location of the displayable region can be changed on the image forming panel in a direction corresponding to the displacement direction.

The projector according to the present invention is characterized in that the image forming means has means for obtaining a parameter required for a predetermined deformation formula for deforming an image formed using the image forming panel so that the image is fitted in the range and keystone correction is carried out for the projection image, on the basis of the coordinates of the range in said panel coordinate system corresponding to said projection range after the displacement; means for deforming the image using the parameter obtained by the means; and means for forming the image deformed by the means in the range on the image forming panel.

In the present invention, the projector projects a projection image on an outer projected surface, such as a screen, by projecting the light to the outside from the image forming panel in which an image is formed. The projector sets a projection range defined as a range occupied by the projection image on the projected surface and displaces the projection range in the projected surface coordinate system in the case that an instruction on displacing the projection image is accepted. The projector converts the coordinates of the projection range after the displacement in the projected surface coordinate system into the coordinates of the range corresponding to the projection range in the panel coordinate system and forms an image in the range corresponding to the projection range on the image forming panel. The image formed in the range corresponding to the projection range after the displacement on the image forming panel is projected, and the projection image is projected in the projection range after the displacement on the projected surface.

Furthermore, in the present invention, the projector makes it possible to displace the projection range by changing the location of the displayable region capable of forming images on the image forming panel. The projector determines the amount of the displacement according to which the projection range is displaced on the projected surface according to the amount of room in which the location of the displayable region can be changed in the direction on the image forming panel corresponding to the displacement direction according to which the projection range should be displaced on the projected surface. Hence, the projector can prevent such a situation in which the range on the image forming panel corresponding to the projection range lies outside the image forming panel and the projection image cannot be projected in the projection range.

Moreover, in the present invention, the projector deforms the image so that the original projection image of the projection image is fitted in the range on the image forming panel corresponding to the projection range, forms a panel image containing the deformed image using the image forming panel, and projects the projection image, thereby carrying out keystone correction for the projection image.

In the present invention, the projector displaces the projection range in the projected surface coordinate system and converts the coordinates of the projection range after the displacement in the projected surface coordinate system into the coordinates in the panel coordinate system, thereby determining the location and the shape of the range in which an image is formed on the image forming panel to project the projection image in the displaced projection range. Hence, the projector can displace the projection image on the projected surface while adjusting keystone correction conditions so that the projection image is subjected to keystone correction even after the displacement. Therefore, the projector can easily displace the projection image on the projected surface without carrying out the keystone correction setting again. In particular, since the time and effort of the user to operate the projector and to carry out the keystone correction setting each time the projection image is displaced on the projected surface are not necessary, the user can easily displace the projection image on the projected surface, and the usability of the projector is improved.

Furthermore, in the present invention, the projector limits the amount of the displacement according to which the projection range is displaced on the projected surface so as to be able to prevent such a situation in which the range on the image forming panel corresponding to the projection range on the projected surface lies outside the image forming panel and the projection image cannot be projected in the projection range. Therefore, the projector can displace the projection image in the range on the projected surface in which the keystone-corrected projection image can be projected securely.

Moreover, in the present invention, the projector deforms the image so that the original projection image of the projection image is fitted in the range on the image forming panel corresponding to the projection range, forms a panel image containing the deformed image using the image forming panel, and projects the projection image. Hence, the projector can easily displace the projection image whose shape has been arranged by keystone correction to a desired location on the projected surface; the present invention has these excellent effects.

The above and further objects and features will more fully be apparent from the following detailed description with accompanying drawings.

### BRIEF DESCRIPTION OF THE SEVERAL VIEWS OF THE DRAWINGS

FIG. 1 is a block diagram showing the internal functional configuration of a projector according to the present invention;

FIG. 2 is a flowchart showing the procedure of the process of setting keystone correction carried out by the projector according to the present invention;

FIG. 3 is a schematic view showing an example of the correspondence between the projection range on a screen and a pattern image formed using a image forming panel;

FIG. 4 is a flowchart showing the procedure of the process of digital shift carried out by the projector according to the present invention;

FIG. 5 is a schematic view showing the correspondence between the projection range on the screen and a panel image formed using the image forming panel;

FIG. 6 is a flowchart showing the procedure of a process in which the projector according to the present invention projects an image while carrying out keystone correction;

FIG. 7 is a schematic view schematically showing a process in which the projector according to the present invention projects an image while carrying out keystone correction; and

FIG. 8 is a schematic view schematically showing the process of deforming the original projection image of a projection image to carry out keystone correction.

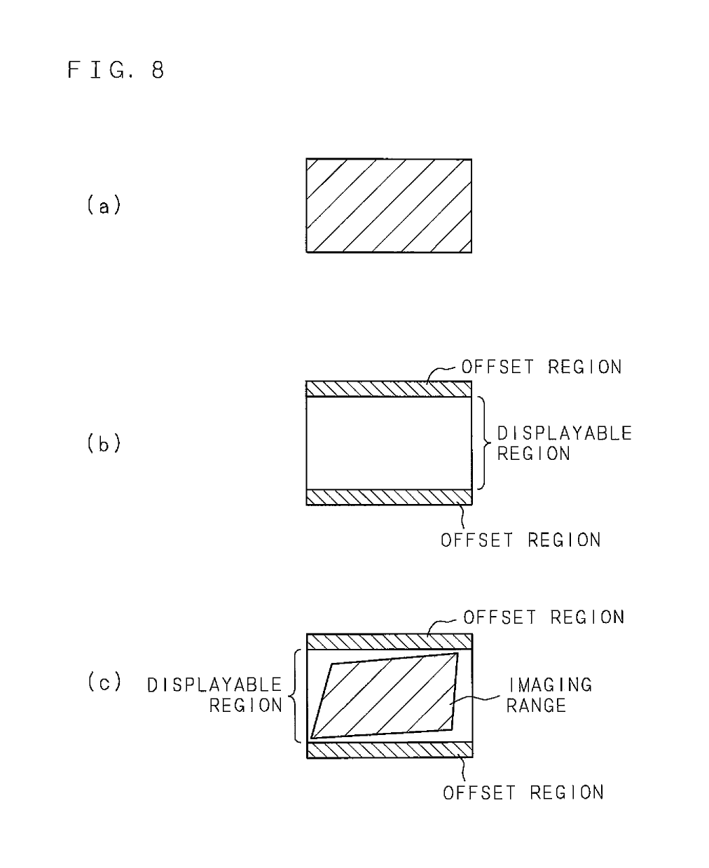

### DETAILED DESCRIPTION

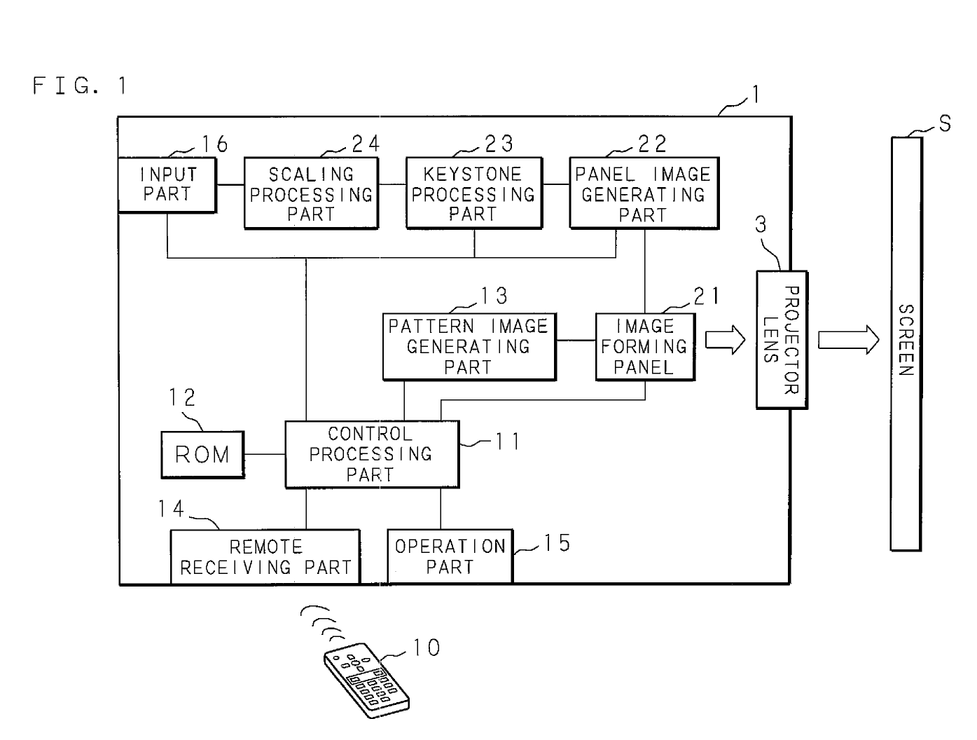

The present invention will be described below specifically on the basis of the drawings showing an embodiment thereof. FIG. 1 is a block diagram showing the internal functional configuration of a projector according to the present invention. A projector 1 has a control processing part 11 comprising a processor for carrying out operations, a RAM for storing information regarding operations, etc. To the control processing part 11, a ROM 12 for storing control programs is connected, and the control processing part 11 carries out processing to control the entire operation of the projector 1 according to the control programs stored in the ROM 12. To the control processing part 11, a remote receiving part 14 for receiving signals transmitted from a remote controller 10 operated by the user using infrared rays or radio waves and an operation part 15, having various switches, for accepting various processing instructions through the operation of the user are connected. The control processing part 11 is configured so as to accept various processing instructions at the remote receiving part 14 or the operation part 15 and carry out processing according to the accepted processing instructions.

Furthermore, the projector 1 is equipped with an image forming panel 21 having a planar shape and formed of a liquid crystal panel or DMD, and the image forming panel 21 has multiple pixels comprising liquid crystals or micromirrors and is configured so as to form a panel image at a predetermined resolution specified by the number of the pixels. The projector 1 is configured so as to irradiate light to the image forming panel 21 using a light source and an optical system, not shown, and is further equipped with a projector lens 3 that projects the light irradiated to the image forming panel 21 on which a panel image is formed and reflected by the image forming panel 21 to the outside. The white arrows in FIG. 1 indicate the light. The light from the projector lens 3 is projected onto a screen (projected surface) S outside the projector 1 and a projection image is projected onto the surface of the screen S. The projector 1 may also be configured so as to project a projection image using the projector lens 3 by projecting the light passed through the image forming panel 21 on which a panel image is formed.

In addition, the projector 1 is equipped with an input part 16 to which image data is input from an external device, such as a television tuner or PC. To the input part 16, a scaling processing part 24 for scaling the image based on the image data input to the input part 16 according to the aspect ratio and the resolution of the projection image is connected. To the scaling processing part 24, a keystone processing part 23 for carrying out keystone correction processing for the image scaled using the scaling processing part 24 is connected. To the keystone processing part 23, a panel image generating part 22 for generating a panel image containing the image that is keystone-corrected using the keystone processing part 23 is connected. The panel image generating part 22 is connected to the image forming panel 21, and the image forming panel 21 is configured so as to form the panel image that is generated using the panel image generating part 22.

Furthermore, to the image forming panel 21, a pattern image generating part 13 for generating a pattern image formed of an outer frame or four corner points indicating the range of a projection image is connected. The projector 1 is configured so that an image indicating the range of projection image is projected onto the screen S by forming the pattern image generated using the pattern image generating part 13, using the image forming panel 21. The input part 16 is connected to the control processing part 11 and configured so as to input information regarding the input image data to the control processing part 11. Moreover, the pattern image generating part 13, the scaling processing part 24, the keystone processing part 23, the panel image generating part 22 and the image forming panel 21 are connected to the control processing part 11 and operate under the control of the control processing part 11.

Next, an image projecting method according to the present invention carried out by the projector 1 according to the present invention configured as described above will be described. The control processing part 11 sets an offset region in which the original projection image of a projection image is not formed and a displayable region in which the original projection image can be formed, in the region for forming an image using the image forming panel 21 according to the aspect ratio and the resolution of a projection image that should be projected on the basis of the image data input to the input part 16. The aspect ratio and the resolution of the projection image are set at values based on the input image data, values specified depending on the configuration of the image forming panel 21 or values set through the operation of the user. When the projector 1 first projects a projection image, the image forming panel 21 forms a panel image such that the original projection image is spread over the entire displayable region. Since the projector 1 is not generally disposed in front of the screen S, the projection image, obtained by forming the panel image by spreading the original projection image over the entire displayable region and by projecting the panel image onto the screen S using the projector 1, is projected in a shape deformed from a rectangular shape. Hence, it is first necessary to correct the keystone distortion of the projection image by carrying out keystone correction.

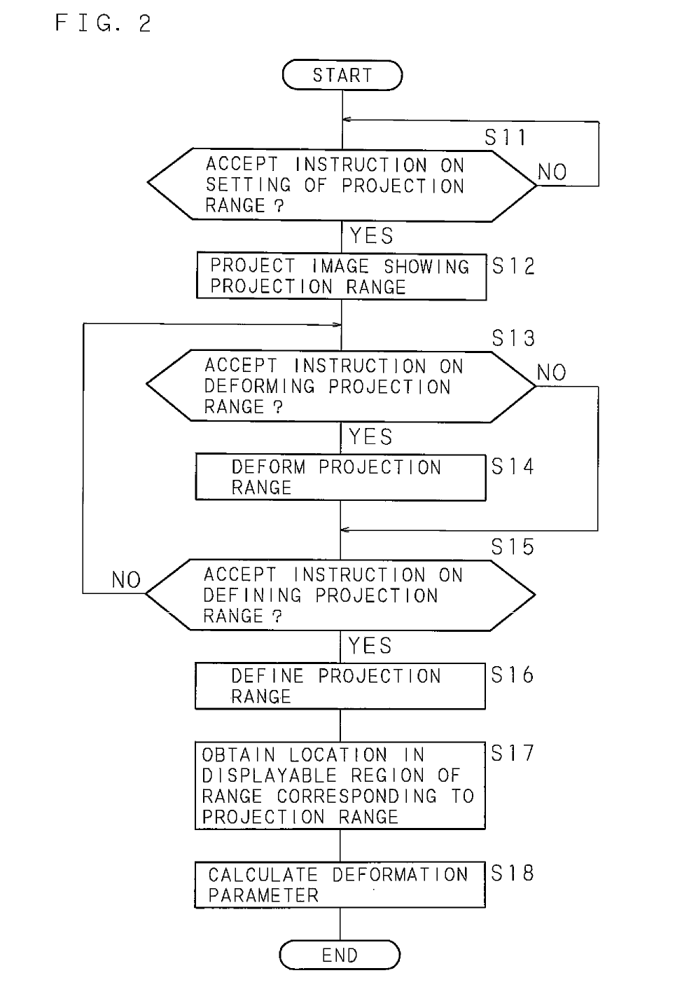

FIG. 2 is a flowchart showing the procedure of the process of setting keystone correction carried out by the projector 1 according to the present invention. The control processing part 11 waits for the acceptance of an instruction on the setting of the projection range occupied by the projection image on the screen S, the instruction being given when the user carries out a predetermined operation through the operation part 15 or when the user carries out a predetermined operation through the remote controller 10 and the remote receiving part 14 receives a predetermined signal transmitted from the remote controller 10 (at step S11). In the case that there is no acceptance of the instruction on the setting of the projection range (NO at step S11), the control processing part 11 continues to wait for the acceptance of the instruction. In the case that the instruction on the setting of the projection range is accepted (YES at Step S11), the control processing part 11 causes the pattern image generating part 13 to generate a pattern image in which the displayable region and the offset region according to the aspect ratio and the resolution of the projection image are contained and an image corresponding to the projection range is spread over the entire displayable region. The control processing part 11 causes the image forming panel 21 to form the generated pattern image and projects an image showing the projection range onto the screen S by projecting the light reflected by image forming panel 21 from the projector lens 3 (at step S12). At this time, the projector 1 projects an image having four bright points corresponding to the four corners of the projection range onto the screen S. The projector 1 may carry out processing for projecting an image having bright lines corresponding to the outer frame of the projection range.

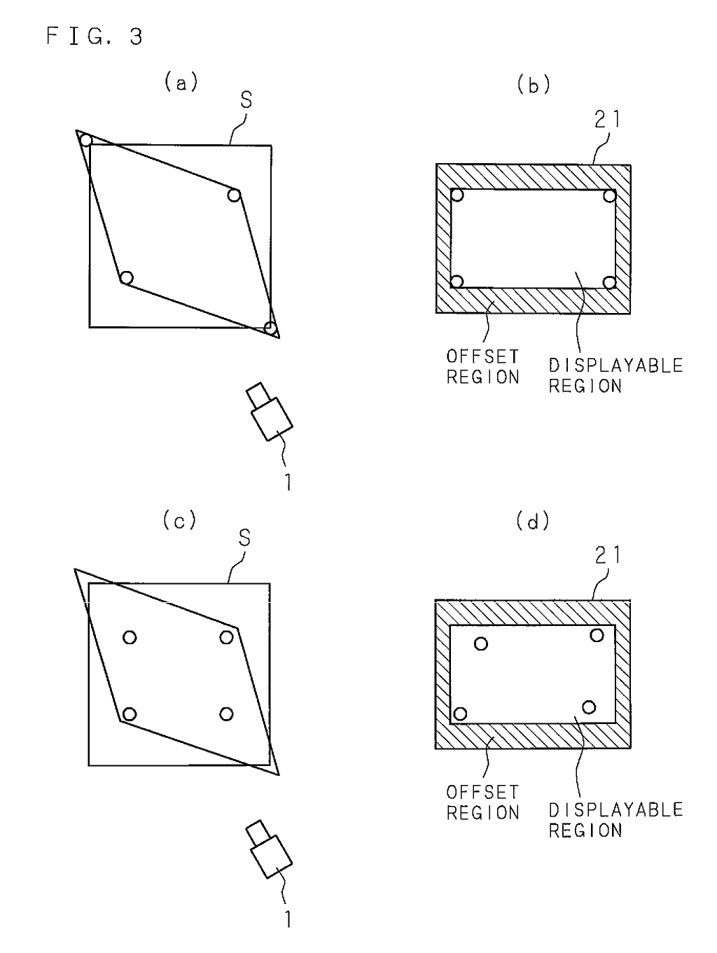

FIG. 3 is a schematic view showing an example of the correspondence between the projection range on the screen S and a pattern image formed using the image forming panel 21. FIG. 3(a) shows an example of an image projected onto the screen S by the projector 1 in the case that the pattern image is formed over the entire displayable region of the image forming panel 21. FIG. 3(b) shows the image forming panel 21 on which the pattern image is formed over the entire displayable region. The white circles in the figure indicate bright points corresponding to the four corners of the projection range. In the case that the entire displayable region corresponds to the projection range, the shape of the projection range is generally deformed from the rectangular shape as shown in FIG. 3(a). The user having visually recognized such an image as shown in FIG. 3(a) operates the operation part 15 or the remote controller 10 to input an instruction on deforming the projection range by displacing the bright points corresponding to the four corners of the projection range.

After step S12 is completed, the control processing part 11 waits for the acceptance of an instruction on deforming the projection range (at step S13). In the case that the instruction on deforming the projection range is accepted (YES at Step S13), the control processing part 11 displaces the locations of the bright points contained in the pattern image generated using the pattern image generating part 13, thereby displacing the locations of the bright points projected onto the screen S and deforming the projection range (at step S14). In the case that the instruction on deforming the projection range is not accepted at step S13 (NO at Step S13) or after step S14 is completed, the control processing part 11 waits for the acceptance of an instruction on defining the projection range through the operation of the user on the operation part 15 or the remote controller 10 (at step S15). In the case that the instruction on defining the projection range is not accepted (NO at step S15), the control processing part 11 returns the process to step S13. In the case that the instruction on defining the projection range is accepted (YES at step S15), the control processing part 11 defines the projection range corresponding to the pattern image generated using the pattern image generating part 13 (at step S16).

FIG. 3(c) shows the projection range defined on the screen S. The user operates the projector 1 while visually recognizing the projected image so that the projection range becomes a rectangular shape as shown in the figure. The range enclosed with the four bright points shown in the figure becomes a projection range, and the projection range is located in the projection range having four corners indicated by the bright points. FIG. 3(d) shows the image forming panel 21 on which the pattern image corresponding to the projection range defined on the screen S is formed. As the bright points corresponding to the four corners of the projection range are displaced on the screen S and the projection range becomes to have a rectangular shape, the bright points corresponding to the four corners of the projection range and located on the image forming panel 21 are also displaced in the displayable region. The range enclosed with the four bright points in the displayable region is the range on the image forming panel 21 corresponding to the projection range, and the image formed in this range is projected as a projection image.

The control processing part 11 obtains a location in the displayable region of the range on the image forming panel 21 corresponding to the projection range (at step S17). For example, in the case that A and B are natural numbers and that the displayable region contains A×B pixels on the image forming panel 21, the control processing part 11 determines the coordinates of the pixels in the displayable region using (x, y), 0≦x≦A and 0≦y≦B, on the assumption that the coordinates of the pixel at the upper left corner of the displayable region are (0, 0) and determines the coordinates of the pixels at which the bright points on the image forming panel 21 corresponding to the four corners of the projection range are located, thereby obtaining the location of the range corresponding to the projection range in the displayable region.

Next, the control processing part 11 calculates a deformation parameter required for a predetermined deformation formula for deforming the shape of the displayable region into the form of the range corresponding to the projection range (at step S18). This deformation is coordinate conversion for converting the location of each point contained in the displayable region into the location of each point contained in the range corresponding to the projection range by projection conversion in the coordinate system for specifying the location in the displayable region, and a general conversion formula is known in which coordinate conversion for mutually converting the locations is carried out by projection conversion. The control programs stored in the ROM 12 contain this conversion formula, and the control processing part 11 uses this conversion formula as a deformation formula and calculates the deformation parameter contained in the deformation formula on the basis of the locations of the range on the image forming panel 21 corresponding to the four corners of the projection range in the displayable region. The control processing part 11 stores the deformation parameter used for the calculation and completes the process for setting the projection range.

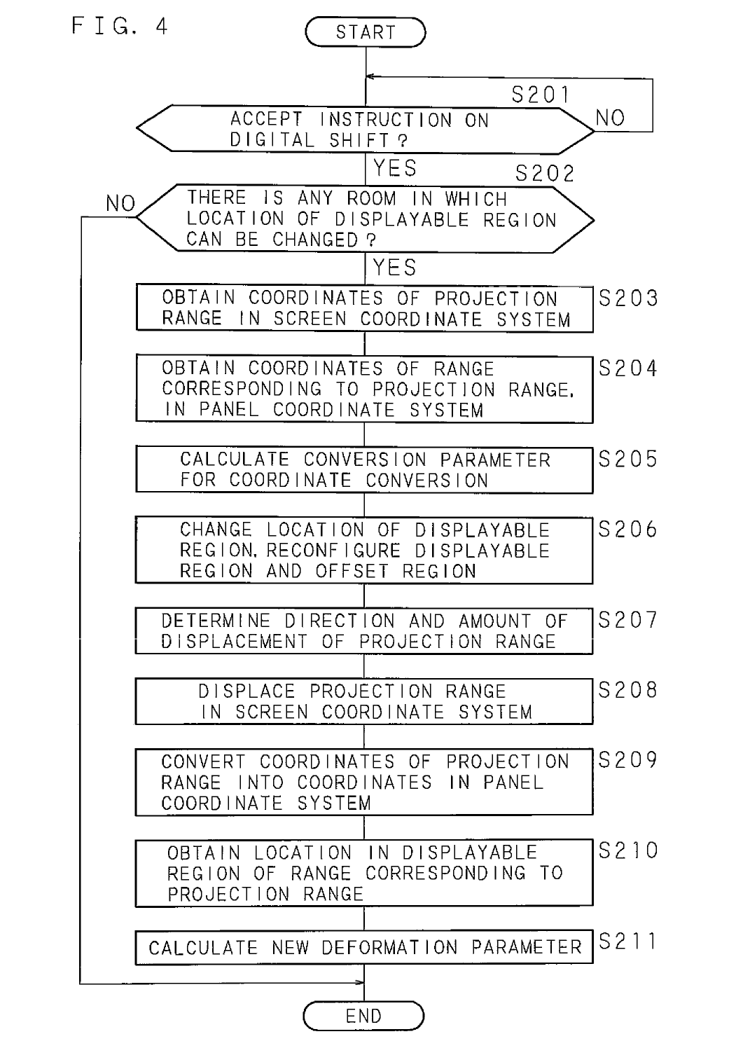

After the projection range is set, according to a process described later the projector 1 projects a projection image based on the image data input to the input part 16 while carrying out keystone correction so that the projection image is projected in the projection range having been set. In addition, the projector 1 according to the present invention can carry out a process for changing the setting of the keystone correction so that the projection range having been set once is displaced on the screen S by digital shift and so that the projection image is projected in the displaced projection range. FIG. 4 is a flowchart showing the procedure of the process of digital shift carried out by the projector 1 according to the present invention.

In the state in which the projector 1 projects the pattern image or the projection image in the projection range having been set on the screen S, the control processing part 11 waits for the acceptance of an instruction on digital shift through a predetermined operation of the user, having visually recognized the pattern image or the projection image, on the operation part 15 or the remote controller 10 (at step S201). The instruction on digital shift is input, for example, when the user presses the cursor key provided on the operation part 15 or the remote controller 10 for a predetermined time, and contains information on instructing the displacement direction and the displacement distance according to which the projection range is displaced on the screen S. The instruction on digital shift corresponds to the displacement instruction according to the present invention. In the case that the instruction on digital shift is not accepted (NO at step S201), the control processing part 11 continues to wait for the acceptance of the instruction on digital shift. In the case that the instruction on digital shift is accepted (YES at Step S201), the control processing part 11 judges whether there is any room in which the location of the displayable region can be changed on the image forming panel 21 in the direction on the image forming panel 21 corresponding to the displacement of the projection range in the displacement direction according to the instruction on digital shift, on the basis of the setting of the displayable region and the offset region on the image forming panel 21 in this stage (at step S202). In the case that the offset region is present in the direction corresponding to the displacement direction of the projection range as viewed from the displayable region on the image forming panel 21, it is assumed that there is room in which the location of the displayable region can be changed. In the case that there is no room in which the location of the displayable region can be changed in the direction on the image forming panel 21 corresponding to the displacement direction of the projection range (NO at step S202), the control processing part 11 completes the process. At this time, the control processing part 11 may carry out the process for projecting a projection image indicating that further digital shift cannot be carried out in the instructed displacement direction, by forming a predetermined image on the image forming panel 21.

In the case that there is room in which the location of the displayable region can be changed in the direction on the image forming panel 21 corresponding to the displacement direction of the projection range at step S202 (YES at step S202), the control processing part 11 obtains the coordinates of the projection range in this stage in the screen coordinate system (projected surface coordinate system) for specifying the location on the screen S (at step S203). At this time, the control processing part 11 defines the screen coordinate system in which the locations of the pixels contained in the projection range are determined according to the aspect ratio and the resolution of the projection range. For example, in the case that the resolution of the projection range is A×B wherein A and B are natural numbers, the control processing part 11 defines the screen coordinate system so that the coordinates of the four corners of the projection range on the screen S are (0, 0), (0, B), (A, 0) and (A, B), respectively, and obtains the coordinates of the projection range.

Next, the control processing part 11 obtains the coordinates of the range on the image forming panel 21 corresponding to the projection range on the screen S by projection in the panel coordinate system for specifying the location on the image forming panel 21 (at step S204). At this time, the control processing part 11 obtains the coordinates of the range corresponding to the projection range in the panel coordinate system by adding the location of the displayable region on the image forming panel 21 to the location in the displayable region of the range on the image forming panel 21 corresponding to the projection range determined (obtained) at step S17. For example, in the case that the image forming panel 21 comprises C×D pixels, the control processing part 11 defines the panel coordinate system by determining the coordinates of the pixels on the image forming panel 21 using (x, y), 0≦x≦C and 0≦y≦D, on the assumption that the coordinate of the pixel at the upper left corner of the image forming panel 21 is (0, 0). Furthermore, in the case that A<C and B<D are established, that the displayable region contains A×B pixels and that the displayable region is located at the center of the image forming panel 21, the widths of the offset region located around the displayable region are (C−A)/2 in the direction x and (D−B)/2 in the direction y. Hence, the control processing part 11 obtains the coordinates of the range corresponding to the projection range in the panel coordinate system by converting the location (x, y) in the displayable region of the range corresponding to the projection range determined (obtained) at step S17 into the location (x+(C−A)/2, y+(D−B)/2) on the image forming panel 21.

Next, the control processing part 11 calculates the conversion parameter contained in the predetermined conversion formula for carrying out mutual coordinate conversion between the location in the panel coordinate system and the location in the screen coordinate system (at step S205). This conversion is coordinate conversion attained by carrying out projection conversion between the panel coordinate system and the screen coordinate system, and a general conversion formula is known in which the coordinate conversion between the coordinates of a point in the panel coordinate system and the coordinates of a point in the screen coordinate system is carried out by projection conversion. The control programs stored in the ROM 12 contain this conversion formula, and the control processing part 11 calculates the conversion parameter contained in the conversion formula, on the basis of the relationship between the coordinates of the projection range in the screen coordinate system obtained at step S203 and the coordinates of the range corresponding to the projection range in the panel coordinate system obtained at step S204. The control processing part 11 stores the conversion parameter obtained by the calculation.

Next, the control processing part 11 changes the location of the displayable region on the image forming panel 21 by the displacement distance on the image forming panel 21 corresponding to the displacement distance of the projection range according to the instruction on digital shift in the displacement direction on the image forming panel 21 corresponding to the displacement direction of the projection range according to the accepted instruction on digital shift, and reconfigures the disposition of the displayable region and the offset region contained in the image forming panel 21. At this time, the control processing part 11 reduces the offset region being present in the displacement direction of the displayable region and increases the offset region on the opposite side of the displacement direction. Furthermore, in the case that the displacement distance specified by the accepted instruction on digital shift is not less than the amount of the offset region serving as room in which the location of the displayable region is changed, the control processing part 11 reduces the offset region being present in the displacement direction of the displayable region and obtains the maximum displacement distance.

Next, the control processing part 11 determines the direction and the amount of displacement according to which the projection range should be displaced in the screen coordinate system according to the instruction on digital shift, by carrying out coordinate conversion for the direction and the distance according to which the location of the displayable region is changed in the panel coordinate system using the conversion formula and the conversion parameter for converting coordinates in the panel coordinate system into those in the screen coordinate system (at step S207). Next, the control processing part 11 displaces the coordinates of the projection range by the amount of displacement determined in the displacement direction that is determined in the screen coordinate system (at step S208). The control processing part 11 then converts the coordinates of the projection range displaced in the screen coordinate system into the coordinates of the range corresponding to the projection range in the panel coordinate system, using the conversion formula and the conversion parameter for converting the coordinates in the screen coordinate system into those in the panel coordinate system (at step S209). The converted coordinates of the range corresponding to the projection range in the panel coordinate system are contained in the displayable region on the image forming panel 21.

Next, the control processing part 11 obtains the location in the displayable region of the range corresponding to the projection range (at step S210). At this time, the control processing part 11 can obtain the location in the displayable region of the range corresponding to the projection range by subtracting the amount contributed by the offset region from the coordinates of the range in the panel coordinate system corresponding to the projection range. For example, in the case that the coordinates of the pixel at the upper left corner of the displayable region is (X, Y), by converting the coordinates (x, y) of the pixel contained in the range corresponding to the projection range in the panel coordinate system into coordinates (x−X, y−Y), it is possible to obtain the location of the range corresponding to the projection range in the coordinate system representing the location in the displayable region in which the pixel at the upper left corner of the displayable region is the origin (0, 0). The control processing part 11 then calculates a new deformation parameter required for a predetermined deformation formula for deforming the shape of the displayable region into the shape of the range corresponding to the projection range (at step S211) and stores the calculated deformation parameter and completes the process.

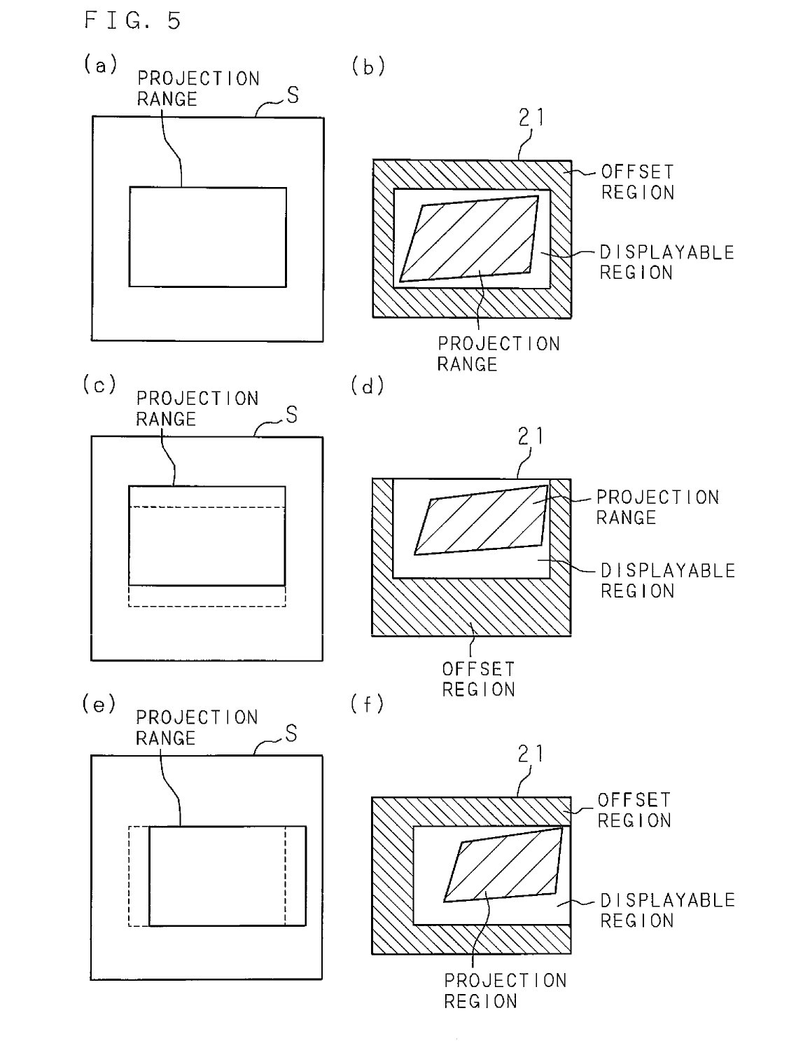

FIG. 5 is a schematic view showing the correspondence between the projection range on the screen S and a panel image formed on the image forming panel 21. FIG. 5(a) shows a projection range not subjected to digital shift. FIG. 5(b) shows a panel image not subjected to digital shift. The displayable region is located at the center of the image forming panel 21, an offset region is located around it, and the projection range is set on the screen S; on the other hand, the range corresponding to the projection range is contained in the displayable region. FIG. 5(c) shows a projection range subjected to digital shift carried out upward on the screen S, and the projection range before the digital shift is indicated by broken lines. FIG. 5(d) shows a panel image subjected to digital shift carried out upward on the screen S. As viewed from the displayable region, the offset region in the direction corresponding to the upward direction of the screen S is reduced, and the location of the displayable region is changed so that part of the displayable region is located at the portion in which the offset region is reduced. The portion occupied by the displayable region before the change of the location has become a new offset region. The range on the image forming panel 21 corresponding to the projection range is contained in the displayable region at the location and in the shape different from those of the projection range before the displacement of the projection range so that the shape of the projection range after the displacement can be represented.

FIG. 5(e) shows a panel image subjected to digital shift carried out sideways on the screen S, and the projection range before the digital shift is indicated by broken lines. FIG. 5(f) shows a panel image subjected to digital shift carried out sideways on the screen S. The location of the displayable region is (hanged in the direction corresponding to the displacement direction of the projection range, and the range corresponding to the projection range on image forming panel 21 is contained in the displayable region at the location and in the shape capable of representing the shape of the projection range after the displacement. Although an example in which the projection range on the screen S is displaced in the up-down direction or the left-right direction in FIG. 5, the projector 1 is configured so as to be able to carry out the process for displacing the projection range on the screen S in the up-down direction and the left-right direction simultaneously.

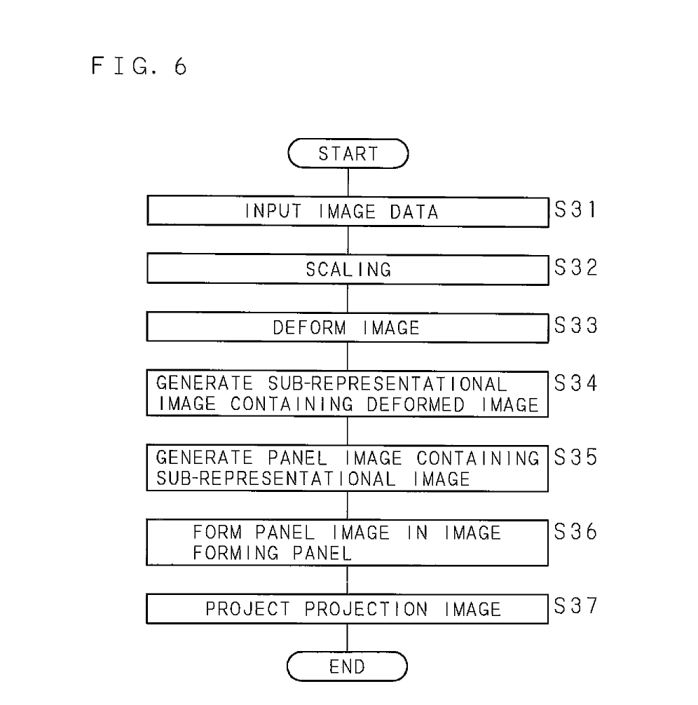

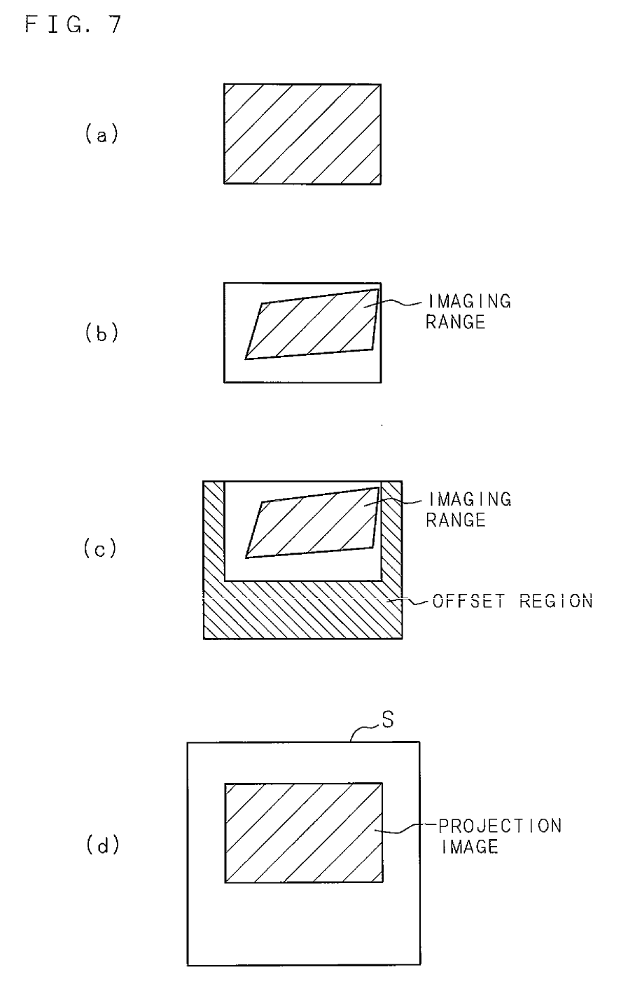

By carrying out the above-mentioned process, the projector 1 displaces the projection range that is defined as the range occupied by the projection image on the screen S as much as possible and sets a new projection range. After setting the projection range, the projector 1 projects the projection image based on the image data input to the input part 16 while carrying out keystone correction so that the projection image is projected in the projection range having been set. FIG. 6 is a flowchart showing the procedure of a process in which the projector 1 according to the present invention projects an image while carrying out keystone correction, and FIG. 7 is a schematic view schematically showing a process in which the projector 1 projects an image while carrying out keystone correction. By carrying out the process shown in the flowchart of FIG. 2 or FIG. 4, the displayable region and the offset region contained in the panel image are set, and the range corresponding to the projection range is set in the displayable region as shown in FIGS. 5(b), 5(d) and 5(f).

Image data is input to the input part 16 from the outside (at step S31), and the scaling processing part 24 scales the image based on the input image data according to the resolution of the displayable region on the image forming panel 21 (at step S32). FIG. 7(a) shows an image that is scaled according to the resolution of the displayable region. Next, the control processing part 11 causes the keystone processing part 23 to deform the scaled image using the deformation formula and the deformation parameter for keystone correction calculated at step S18 or step S211 (at step S33), and the keystone processing part 23 generates a sub-representational image containing the deformed image (at step S34). FIG. 7(b) shows an example of the sub-representational image. The imaging range shown in the figure corresponds to the image deformed by keystone correction and is ultimately a range corresponding to the projection image. Next, the panel image generating part 22 generates a panel image containing the portion corresponding to the offset region and the sub-representational image (at step S35). FIG. 7(c) shows an example of the panel image. The panel image contains the offset region, and the portion of the displayable region contains the sub-representational image. Furthermore, the imaging range is located in the range in the displayable region corresponding to the projection range. Next, the control processing part 11 causes the image forming panel 21 to form the panel image generated using the panel image generating part 22 (at step S36), and projects the keystone-corrected projection image onto the screen S by projecting the light reflected by the image forming panel 21 from the projector lens 3 (at step S37). FIG. 7(d) shows an example of the projection image. The keystone-corrected projection image having a rectangular shape is projected at the location set on the screen S according to the location and the shape of the imaging range on the image forming panel 21.

As detailed above, in the present invention, when a projection image is projected on the screen S by the projector 1, the projection range defined as the range occupied by the projection image on the screen S is set in a rectangular shape, and the range on the image forming panel 21 corresponding to the projection range is obtained by the projection. The projector 1 carries out keystone correction by forming an original projection image in the obtained range and projects a rectangular projection image to the screen S. Furthermore, in the case that the instruction on digital shift is accepted, the projector 1 according to the present invention displaces the projection range in the screen coordinate system according to the accepted instruction, and converts the coordinates of the projection range after the displacement in the screen coordinate system into the coordinates in the panel coordinate system, thereby obtaining the location of the range on the image forming panel 21 corresponding to the projection range on the screen S. At this time, the projector 1 changes the locations of the displayable region and the offset region on the image forming panel 21 so that the range corresponding to the projection range is contained in the displayable region. The projector 1 deforms the image so that the original projection image is fitted in the range on the image forming panel 21 corresponding to the projection range, forms a panel image containing the deformed image using the image forming panel 21, and projects the projection image, thereby carrying out keystone correction for the projection image. As a result, the projection image is projected in the projection range on the screen S, and the projection image which is displaced on the screen S by digital shift and whose shape is arranged in a rectangular shape by keystone correction is projected onto the screen S.

As described above, in the present invention, the projector 1 displaces the projection range in the screen coordinate system and converts the coordinates of the projection range after the displacement in the screen coordinate system into the coordinates in the panel coordinate system, thereby determining the location and the shape of the range in which an image is formed on the image forming panel 21 to project the projection image in the displaced projection range having a rectangular shape. Hence, in the present invention, the projector 1 can carry out digital shift for the projection image while adjusting keystone correction conditions so that the keystone-corrected projection image is projected even after the displacement on the screen S. Therefore, the projector 1 can easily displace the projection image on the screen S without carrying out the keystone correction setting again. In particular, since the time and effort of the user to operate the projector 1 and to carry out the keystone correction setting each time the projection image is displaced on the screen S are not necessary, the user can easily displace the projection image on the screen S, and the usability of the projector 1 is improved.

Furthermore, in the projector 1 according to the present invention, digital shift is made possible by changing the location of the displayable region capable of forming images on the image forming panel 21, and the amount of the displacement according to which the projection range is displaced on the screen S is determined according to the amount of room in which the location of the displayable region can be changed in the direction on the image forming panel 21 corresponding to the displacement direction according to which the projection range should be displaced. Hence, the projector 1 limits the amount of the displacement according to which the projection range is displaced on the screen S so as to be able to prevent such a situation in which the range on the image forming panel 21 corresponding to the projection range lies outside the image forming panel 21 and the projection image cannot be projected in the projection range. Therefore, the projector 1 according to the present invention can displace the projection image in the range on the screen S in which the keystone-corrected projection image can be projected securely.

In this embodiment, the projector 1 according to the present invention is disclosed as a mode in which the projection range is set on the screen S through the operation of the user to carry out the keystone correction setting; however, without being limited to this, it may be possible to use a mode in which the pattern image projected onto the screen S is photographed and the projection range is set automatically so that the photographed pattern image has a rectangular shape. Even in this mode, the projector 1 according to the present invention can easily displace the projection image on the screen S without carrying out the keystone correction setting again. In addition, although an example in which the projector 1 projects the projection image onto the screen S is described in this embodiment, the projector 1 according to the present invention is configured so as to be able to project the keystone-corrected projection image by carrying out processes similar to those described above even in the case that the projected surface according to the present invention is a house wall or the like.

1-4. (canceled)

5. An image projecting method for projecting a projection image from a projector onto an outer projected surface by forming an image using an image forming panel and by projecting the light from said image forming panel in which the image is formed to said projected surface, comprising the steps of:
setting a projection range occupied by the projection image on said projected surface;
determining coordinates of said projection range in a projected surface coordinate system specifying locations on said projected surface;
in the case that a displacement instruction on instructing that said projection range should be displaced on said projected surface is accepted, displacing the coordinates of said projection range in said projected surface coordinate system according to said accepted displacement instruction;
converting the coordinates of said projection range obtained after the displacement in said projected surface coordinate system into coordinates of a range corresponding to said projection range after the displacement in a panel coordinate system specifying locations on said image forming panel; and
forming an image in the range on said image forming panel corresponding to said projection range obtained after the displacement and represented by the converted coordinates.

6. A projector, comprising:
an image forming panel;
a controller capable of.
projecting a projection image onto an outer projected surface by projecting the light from said image forming panel in which an image is formed to said projected surface;
setting a projection range occupied by the projection image on said projected surface;
obtaining coordinates of a range on said image forming panel corresponding to said projection range on said projected surface by projection in a panel coordinate system specifying locations on said image forming panel;
determining coordinates of said projection range in a projected surface coordinate system specifying locations on said projected surface; and
calculating a conversion parameter required for a predetermined conversion formula for carrying out mutual conversion between the locations in said panel coordinate system and the locations in said projected surface coordinate system corresponding thereto by projection, on the basis of the coordinates of the range corresponding to said projection range in said panel coordinate system and the coordinates of said projection range in said projected surface coordinate system; and
an accepting part for accepting a displacement instruction on instructing that said projection range should be displaced on said projected surface, wherein
said controller is further capable of:
displacing said projection range in said projected surface coordinate system according to said displacement instruction accepted by said accepting part;
converting the coordinates of said projection range in said projected surface coordinate system after displacement into coordinates of a range in said panel coordinate system corresponding to said projection range after the displacement, using said conversion parameter; and
forming an image in the range on said image forming panel corresponding to said projection range obtained after the displacement and represented by the converted coordinates.

7. The projector according to claim 6, wherein
said displacement instruction contains information regarding a displacement direction in which said projection range is displaced in said projected surface coordinate system, and
said controller is further capable of:
setting a displayable region in which an image can be formed in a portion of said image forming panel according to the aspect ratio of the projection image that should be projected; and
determining an amount of displacement of said projection range in said projected surface coordinate system according to said displacement instruction, depending on an amount of room in which the location of said displayable region can be changed on said image forming panel in a direction corresponding to said displacement direction.

8. The projector according to claim 6, wherein said controller is further capable of:
obtaining a parameter required for a predetermined deformation formula for deforming an image formed using said image forming panel so that said image is fitted in said range and keystone correction is carried out for said projection image, on the basis of the coordinates of the range in said panel coordinate system corresponding to said projection range after the displacement;
deforming said image using said obtained parameter; and
forming said deformed image in said range on said image forming panel.

9. A projector, comprising:
an image forming panel;
means for projecting a projection image onto an outer projected surface by projecting the light from said image forming panel in which an image is formed to said projected surface;
means for setting a projection range occupied by the projection image on said projected surface;
means for obtaining coordinates of a range on said image forming panel corresponding to said projection range on said projected surface by projection in a panel coordinate system specifying locations on said image forming panel;
means for determining coordinates of said projection range in a projected surface coordinate system specifying locations on said projected surface;
means for calculating a conversion parameter required for a predetermined conversion formula for carrying out mutual conversion between the locations in said panel coordinate system and the locations in said projected surface coordinate system corresponding thereto by projection, on the basis of the coordinates of the range corresponding to said projection range in said panel coordinate system and the coordinates of said projection range in said projected surface coordinate system;
accepting means for accepting a displacement instruction on instructing that said projection range should be displaced on said projected surface;
displacing means for displacing said projection range in said projected surface coordinate system according to said displacement instruction accepted by said accepting means;
converting means for converting the coordinates of said projection range in said projected surface coordinate system after displacement by said displacing means into coordinates of a range in said panel coordinate system corresponding to said projection range after the displacement, using said conversion parameter; and
image forming means for forming an image in the range on said image forming panel corresponding to said projection range obtained after the displacement and represented by the coordinates converted by said converting means.

10. The projector according to claim 9, wherein
said displacement instruction contains information regarding a displacement direction in which said projection range is displaced in said projected surface coordinate system, and
said projector further comprises.
means for setting a displayable region in which an image can be formed in a portion of said image forming panel according to the aspect ratio of the projection image that should be projected; and
means for determining an amount of displacement of said projection range in said projected surface coordinate system according to said displacement instruction, depending on an amount of room in which the location of said displayable region
can be changed on said image forming panel in a direction corresponding to said displacement direction.

11. The projector according to claim 9, wherein
said image forming means has:
obtaining means for obtaining a parameter required for a predetermined deformation formula for deforming an image formed using said image forming panel so that said image is fitted in said range and keystone correction is carried out for said projection image, on the basis of the coordinates of the range in said panel coordinate system corresponding to said projection range after the displacement;
deforming means for deforming said image using said parameter obtained by said obtaining means; and
means for forming said image deformed by said deforming means in said range on said image forming panel.
